(19) United States
(12) Patent Application Publication
(10) Pub. No.: US 2025/0364633 A1
(43) Pub. Date: Nov. 27, 2025

(54) BATTERY PACK FOR AN ELECTRIC VEHICLE

(71) Applicant: BOMBARDIER RECREATIONAL PRODUCTS INC., Valcourt (CA)

(72) Inventors: Thomas DRIANT, Saint-Francois-Xavier-de-Brompton (CA); Jean GUILLEMETTE, Valcourt (CA)

(21) Appl. No.: 18/873,972

(22) PCT Filed: Jun. 27, 2023
(86) PCT No.: PCT/IB2023/056644

§ 371 Date: Dec. 11, 2024

Related U.S. Application Data
(60) Provisional application No. 63/357,090, filed on Jun. 30, 2022.

(51) Int. Cl. H01M 10/6568; B60L 50/64; B60L 58/26; H01M 10/42; H01M 10/613; H01M 10/625; H01M 10/643; H01M 50/213; H01M 50/249; H01M 50/271

(52) U.S. Cl. CPC H01M 10/6568; B60L 50/64; B60L 58/26; H01M 10/425; H01M 10/613; H01M 10/625; H01M 10/643; H01M 50/213; H01M 50/249; H01M 50/271; B60L 2210/10; H01M 2220/20

(57) ABSTRACT

A battery pack for an electric vehicle, the battery pack including a battery housing including: a housing body, at least one heat transfer channel defined in the housing body, the at least one heat transfer channel extending generally through a center portion of the housing body, the at least one heat transfer channel being operative to convey a heat transfer fluid; a plurality of battery cells disposed in the housing body, the plurality of battery cells being disposed in direct thermal communication with the at least one heat transfer channel; and at least one electronic component disposed in the battery housing, the at least one electronic component being in direct thermal communication with the at least one heat transfer channel.

### CROSS-REFERENCE

The present application claims priority to U.S. Provisional Patent Application No. 63/357,090, entitled “Battery Pack for an Electric Vehicle,” filed Jun. 30, 2022, the entirety of which incorporated by reference herein.

### FIELD OF TECHNOLOGY

The present technology relates to battery packs for electric vehicles.

### BACKGROUND

Motorcycles, all-terrain vehicles, side-by-side vehicles, and snowmobiles are popular transport and recreational vehicles. As the move toward electrification of vehicles progresses, interest in battery packs for various recreational vehicles increases.

Different vehicles have different power requirements, such as the total current output or total voltage across the battery assembly. In many recreational and transport vehicles, space available for different electronic components such as a battery pack, charging components, and components for managing power distribution can be strictly limited. When addressing different types of vehicles with different space constraints and different power requirements, the number of designs could quickly multiply. Cooling of different battery and electronic components is further a challenge to be addressed for electric powerpacks in different electric vehicles.

There therefore remains a desire for battery arrangements for electric vehicles addressing at least some of the above-described disadvantages.

### SUMMARY

It is an object of the present technology to ameliorate at least some of the inconveniences present in the prior art.

According to one aspect of the present technology, there is provided a powerpack for an electric vehicle in which battery pack components are arranged in a generally compact manner while maintaining cooling and heat transfer to electronic components on the interior of the battery pack. The battery pack is formed from a plurality of battery cells and a plurality of electronic components, including, but not limited to, a general battery management system, a DC-DC converter, and a battery disconnect unit board. The battery housing also includes a battery heat transfer channel defined through a center thereof. The heat transfer channel is fluidly connected to a heat transfer system of the vehicle, permitting the battery cells to be cooled during operation while maintaining an efficient spatial arrangement of the battery pack. The electronic components are further in direct thermal communication with the heat transfer channel, specifically wherein heat can transfer between the components and the heat transfer channel without traversing air spaces between the components and the heat transfer channel, in order to cool the electronic components. In some cases, for example when operating in cold conditions, the heat transfer channel may also be used to heat the battery cells and the electronic components up to a minimum operating temperature.

According to one aspect of the present technology, there is provided a battery pack for an electric vehicle, the battery pack including a battery housing including: a housing body, at least one heat transfer channel defined in the housing body, the at least one heat transfer channel extending generally through a center portion of the housing body, the at least one heat transfer channel being operative to convey a heat transfer fluid; a plurality of battery cells disposed in the housing body, the plurality of battery cells being disposed in direct thermal communication with the at least one heat transfer channel; and at least one electronic component disposed in the battery housing, the at least one electronic component being in direct thermal communication with the at least one heat transfer channel.

In some embodiments, the at least one electronic component includes a DC-DC converter; and the DC-DC converter is in direct thermal communication with the at least one heat transfer channel.

In some embodiments, at least a portion of the DC-DC converter directly contacts the housing body.

In some embodiments, the at least one heat transfer channel extends generally vertically through the center portion of the housing body.

In some embodiments, the battery pack further includes a first cover selectively connected to the housing body, and a second cover selectively connected to the housing body; and the plurality of battery cells includes: a first plurality of battery cells disposed in a first chamber defined by the housing laterally between the at least one heat transfer channel and the first cover, and a second plurality of battery cells disposed in a second chamber defined by the housing laterally between the at least one heat transfer channel and the second cover.

In some embodiments, each battery cell of the first plurality of battery cells extends generally orthogonally to the at least one heat transfer channel and the first cover; and each battery cell of the second plurality of battery cells extends generally orthogonally to the at least one heat transfer channel and the second cover.

In some embodiments, the second plurality of battery cells has a greater number of battery cells than the first plurality of battery cells, the first chamber having less battery cells disposed therein than the second chamber.

In some embodiments, the first plurality of battery cells is a first plurality of cylindrical battery cells; and the second plurality of battery cells is a second plurality of cylindrical battery cells.

In some embodiments, the at least one electronic component is disposed in the first chamber.

In some embodiments, the housing body includes: a first lateral portion, and a second lateral portion connected to the first lateral portion; the first cover is selectively connected to the first lateral portion; the second cover is selectively connected to the second lateral portion; the at least one heat transfer channel is defined between the first lateral portion and the second lateral portion; and the center portion of the housing body is formed by an inner part of the first lateral portion and an inner part of the second lateral portion.

In some embodiments, an inner face of the first lateral portion includes a first channel form; an inner face of the second lateral portion includes a second channel form; and the at least one heat transfer channel is defined by a space created between the inner face of the first lateral portion and the inner face of the second lateral portion.

In some embodiments, the at least one heat transfer channel is arranged to allow, when in operation, at least one of: heat to be transferred to the heat transfer fluid flowing through the at least one heat transfer channel from the plurality of battery cells and the at least one electronic component; and heat to be transferred from the heat transfer fluid flowing through the at least one heat transfer channel to the plurality of battery cells and the at least one electronic component.

In some embodiments, the at least one heat transfer channel is configured to convey a heat transfer liquid.

For the purposes of the present application, terms related to spatial orientation such as forward, rearward, front, rear, upper, lower, left, and right, are as they would normally be understood by a driver of a vehicle sitting therein in a normal driving position with the vehicle being upright and steered in a straight ahead direction. Specifically, the terms relating to spatial orientation should be understood as they would be understood when the presently described components are mounted to a vehicle, according to at least some embodiments.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, left side perspective view of a battery pack according to non-limiting embodiments of the present technology;

FIG. 2 is a top, rear, right side perspective view of the battery pack of FIG. 1;

FIG. 3 is a left side elevation view of the battery pack of FIG. 1;

FIG. 4 is a perspective, partially-exploded view of portions of a powerpack including the battery pack of FIG. 1;

FIG. 5 is a top, rear, right perspective, partially-exploded view of the battery pack of FIG. 1;

FIG. 6 is a top, rear, right side perspective view of the housing covers and a housing body of the battery pack of FIG. 1;

FIG. 7 is a top, rear, left side perspective view of the battery pack of FIG. 1, with housing covers having been removed;

FIG. 8 is a left side elevation view of the battery pack with housing covers having been removed of FIG. 6;

FIG. 9 is a right side elevation view of the battery pack with housing covers having been removed of FIG. 6;

FIG. 10 is a close-up, top, left side, perspective view of an upper portion of the battery pack with housing covers having been removed of FIG. 6;

FIG. 11A is an exterior perspective view of a DC-DC converter of the battery pack of FIG. 1;

FIG. 11B is an interior perspective view of the DC-DC converter of FIG. 11A;

FIG. 12 is a partial, cross-sectional view of portions of the battery pack of FIG. 1, taken along line 12-12 of FIG. 3;

FIG. 13 is the close-up, top, left side, perspective view of the upper portion of the battery pack with housing covers having been removed of FIG. 10, with the DC-DC converter removed;

FIG. 14 is a partial, cross-sectional view of portions of the battery pack of FIG. 1, taken along line 14-14 of FIG. 8; and

FIG. 15 is another partial, cross-sectional view of portions of the battery pack of FIG. 1, taken along line 15-15 of FIG. 3.

It should be noted that, unless otherwise explicitly specified herein, the drawings are not necessarily to scale.

### DETAILED DESCRIPTION

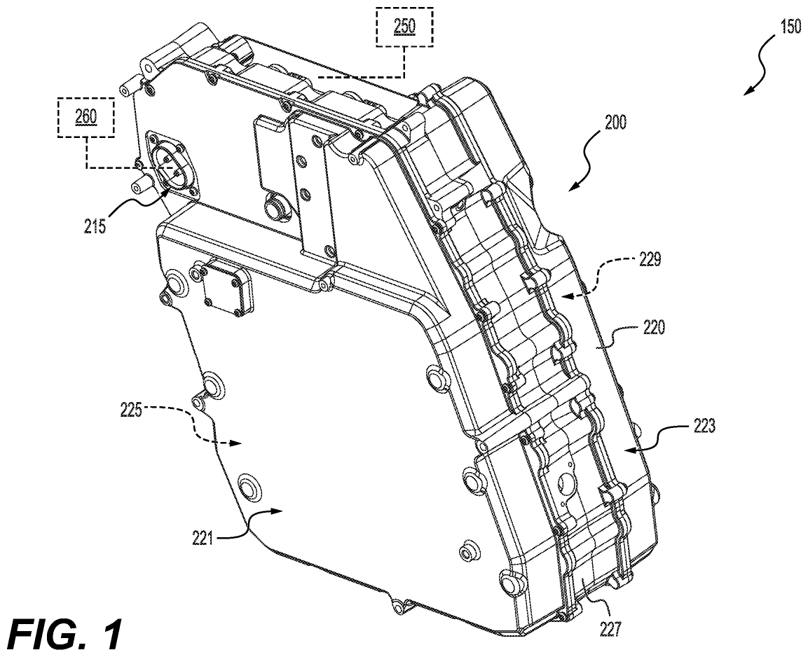

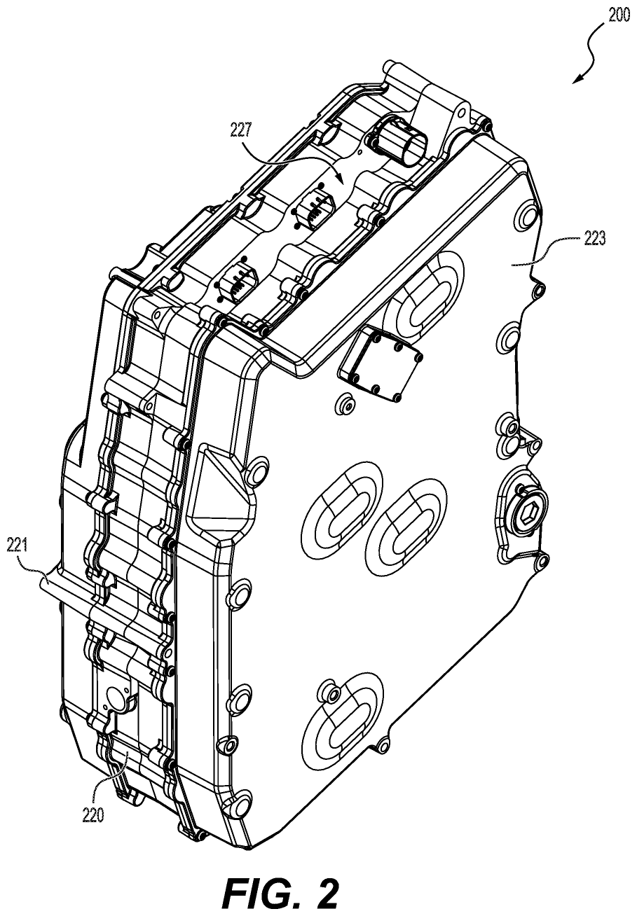

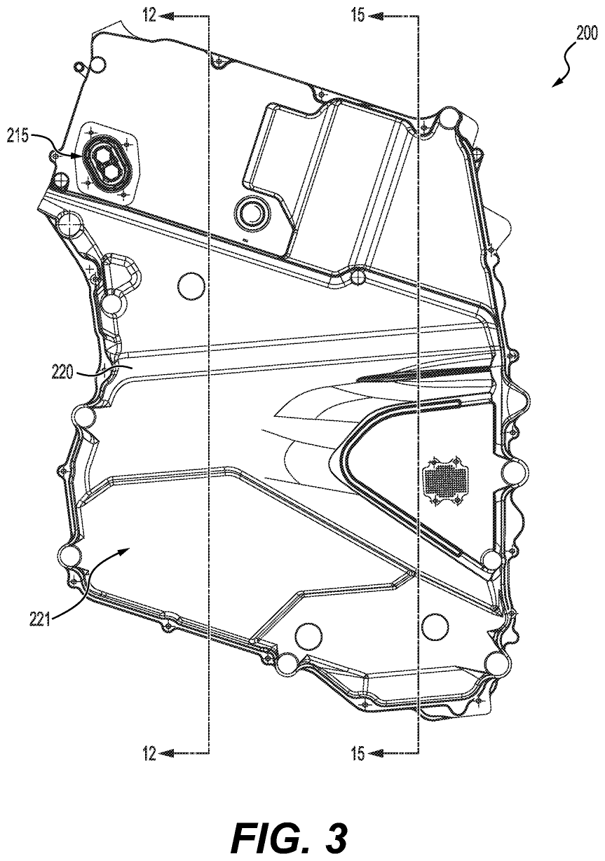

The present technology will be described herein with respect to a battery pack 200, illustrated in FIGS. 1 to 4, for powering an electric vehicle (not shown). The battery pack 200 could be implemented in a variety of vehicle types, including but not limited to two-wheeled straddle-seat electric vehicles (e.g., electric motorcycles, electric scooters), three-wheeled straddle-seat electric vehicles, electric snowmobiles, electric all-terrain vehicles (ATVs), electric side-by-side vehicles (SSVs), and four-wheeled electric vehicles.

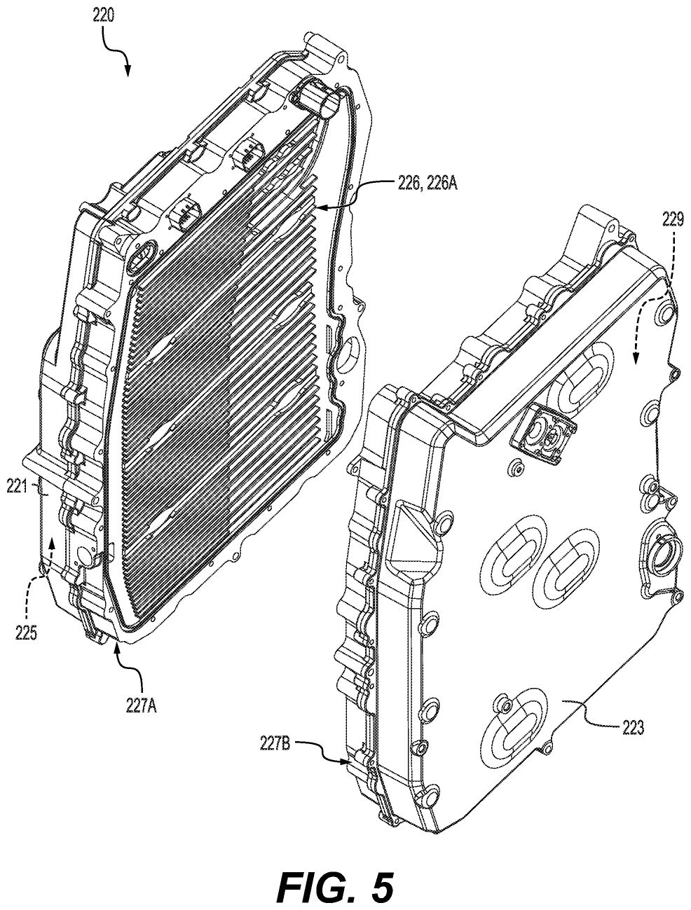

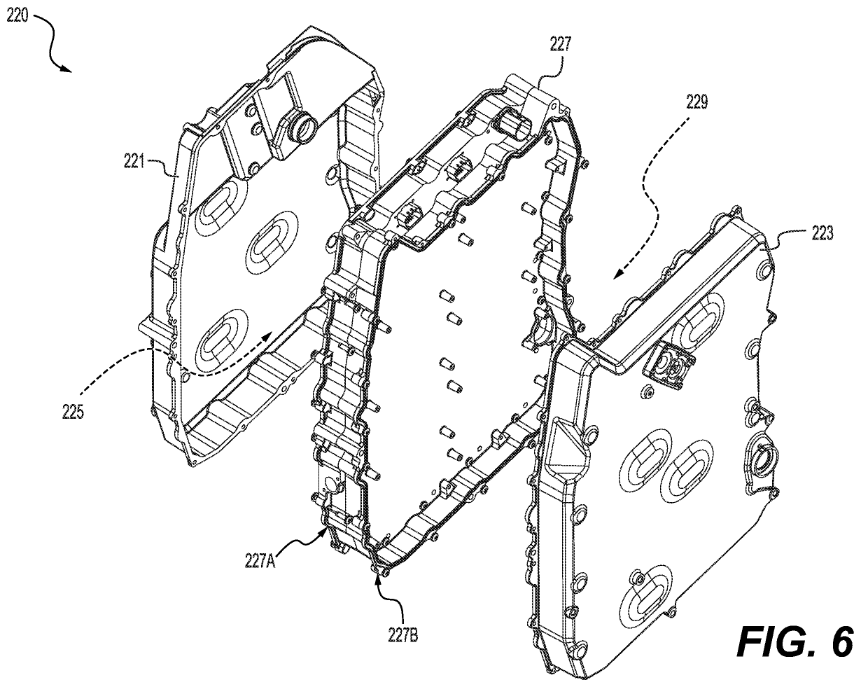

With additional reference to FIGS. 5 and 6, the battery pack 200 includes a battery housing 220. The battery housing 220 encloses different components of the battery pack 200 and provides connections for connecting to other vehicle components (described further below). In the illustrated embodiment of the battery pack 200, the battery housing 220 (and the corresponding layout of components disposed therein) is shaped for use in a straddle-seat vehicle. In different embodiments of the present technology, it is contemplated that the battery housing 220 could be differently shaped. In some non-limiting examples, the battery housing 220 could be shaped for use in a vehicle having side-by-side seating or in four-wheeled electric vehicles having a passenger cabin.

The battery housing 220 includes a housing body 227, forming a center portion of the housing 220. As is illustrated in FIGS. 5, 11, and 12, the housing body 227 includes a left lateral portion 227A and a right lateral portion 227B connected together to form the body 227. In the illustrated embodiment the left and right lateral portions 227A, 227B are selectively connected together via threaded fasteners (not shown). It is contemplated that the left and right lateral portions 227A, 227B could be otherwise connected together in different manners. In the present embodiment, the housing body 227 is formed from aluminum, but could be formed from different materials, including but not limited to plastic or other metals.

The battery housing 220 includes a left side cover 221 selectively connected to the housing body 227, specifically selectively connected to the left lateral portion 227A. The housing 220 similarly includes a right side cover 223 selectively connected to the housing body 227, specifically selectively connected to the right lateral portion 227B. Each cover 221, 223 is selectively fastened to the housing body 227 to encase the components therein. It is contemplated that the covers 221, 223 could be selectively connected to the housing body 227 in different manners, including for example by tabs. A left chamber 225 is formed between the center portion of the housing body 227 and the left cover 221. A right chamber 229 is formed between the center portion of the housing body 227 and the right cover 223. The left and right chambers 225, 229 are shown in the exploded view of FIG. 6.

The battery housing 220 defines a battery heat transfer channel 226 therein, specifically through a center portion of the housing body 227. In some embodiments, it is contemplated that more than one heat transfer channel could be defined through the housing body 227. In the illustrated embodiment, the heat transfer channel 226 extends generally vertically when the battery pack 200 is installed in the electric vehicle. As can be seen in FIG. 5, the battery heat transfer channel 226 includes a plurality of fins extending inward from the housing 220. The battery heat transfer channel 226 is fluidly connected to a heat transfer system (not shown) of the vehicle. Depending on the temperature of operation, the heat transfer system can be used to cool or heat components of the battery pack 200, described in more detail.

When the battery pack 200 is in operation in the vehicle, heat transfer fluid flows through the channel 226 along a longitudinal direction through the center of the housing body 227. In the illustrated embodiment, the heat transfer fluid is specifically a heat transfer liquid, such as ethylene glycol. In the present embodiment, the heat transfer channel 226 extends generally parallel to the covers 221, 223. An inner face of the left lateral portion 227A includes a first channel form 226A formed thereon and an inner face of the right lateral portion 227B includes a second channel form (not shown) formed thereon. The heat transfer channel 226 is then defined by the space created between the left and right lateral portions 227A, 227B.

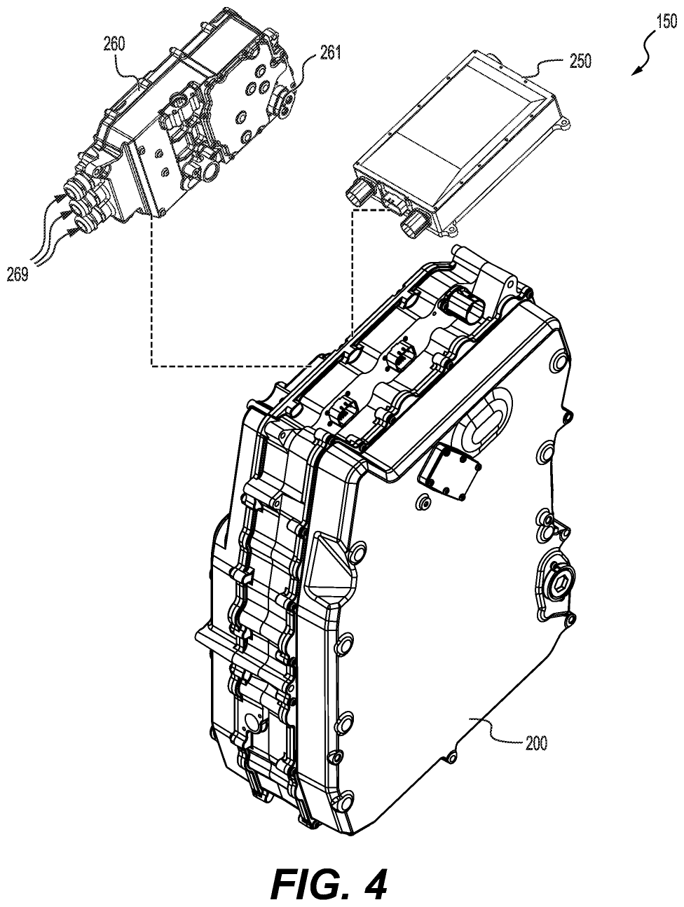

As is partially illustrated in FIG. 4, the battery pack 200 is part of an electric powerpack 150 for powering the electric vehicle (not shown). In addition to the battery pack 200, the powerpack 150 includes a charger 250 connected to the battery pack 200. The charger 250 is mounted to the battery housing 220. Specifically, the charger 250 is fastened to the battery housing 220 and is disposed on a top side of the battery housing 220. It is contemplated that the location of the charger 250 relative to the battery pack 200 could vary.

The charger 250 is electrically connected to battery cells 230 of the battery pack 200 for supplying charge thereto; the battery cells 230 and the connection arrangement are described in more detail below. The charger 250 is configured to electrically connect to a socket (not shown) of the vehicle in which the battery pack 200 is installed for electrically connecting to an external power source for providing electricity to the charger 250 for charging the battery pack 200.

The powerpack 150 also includes an inverter 260 disposed on a left side of the battery pack 200. The inverter 260 is fastened to the battery housing 220, specifically along a left side of the battery housing 220. In some embodiments, it is contemplated that the inverter 260 could be disposed on a different location on the battery pack 200.

The inverter 260 includes an electric connector 261 disposed on an exterior of the inverter 260. The battery pack 200 includes an electric connector 215 electrically connected to the battery cells 230 (described in more detail below). The electric connector 215 is disposed on an exterior of the battery housing 220, specifically on a left side of the housing 220. When the vehicle is in operation, the inverter 260 receives electric power from the battery cells 230 via the electric connector 215 and the electric connector 261.

The connector 215 is arranged to receive the connector 261 of the inverter 260, such that the electric connector 215 and the electric connector 261 are selectively connected together for managing electricity flow from the battery pack 200 to other electronic components of the vehicle via the inverter 260. In at least some embodiments, the inverter 260 is configured to electrically connect to a three-phase motor (not shown) via cables connected to three outlets 269 of the inverter 260. It is contemplated that the number of cables, type of electrical connection, and type of motor operatively connected to the inverter 260 could vary in different embodiments. While the inverter 260 connects directly to the battery pack 200 in the present embodiment, it is contemplated that the inverter 260 could be separated and spaced from the battery pack 200 and electrically connected to the battery cells 230 via cables or the like.

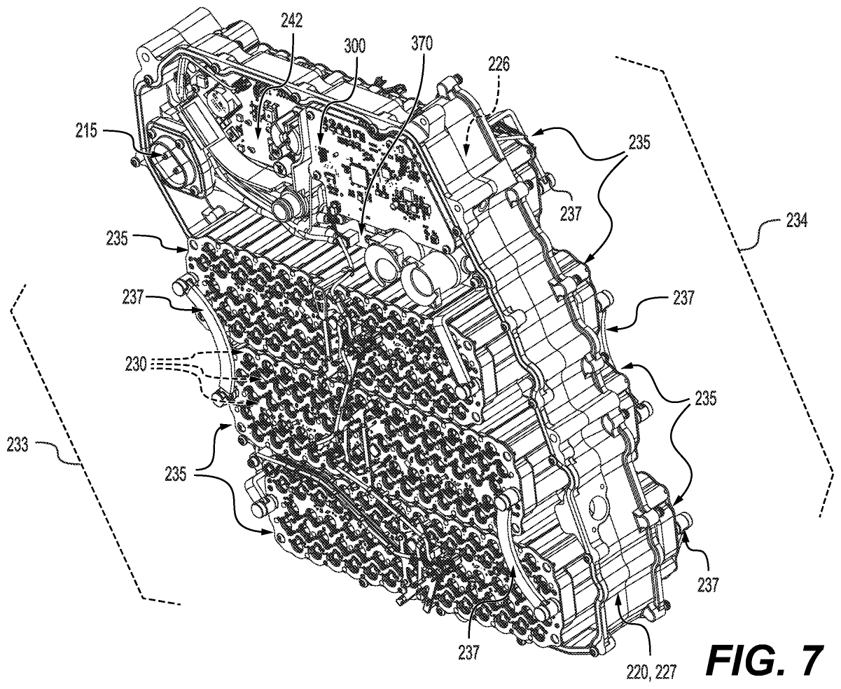

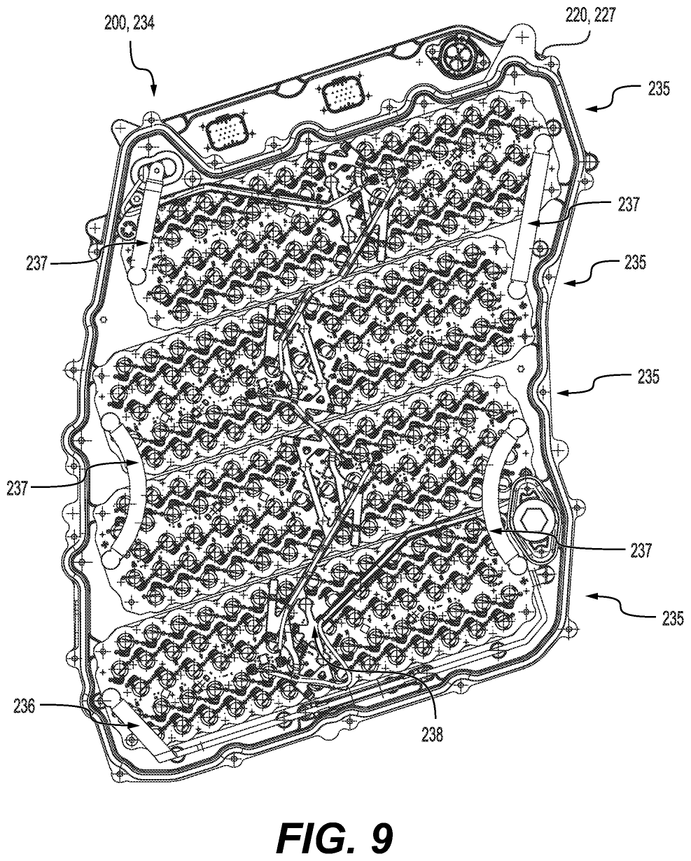

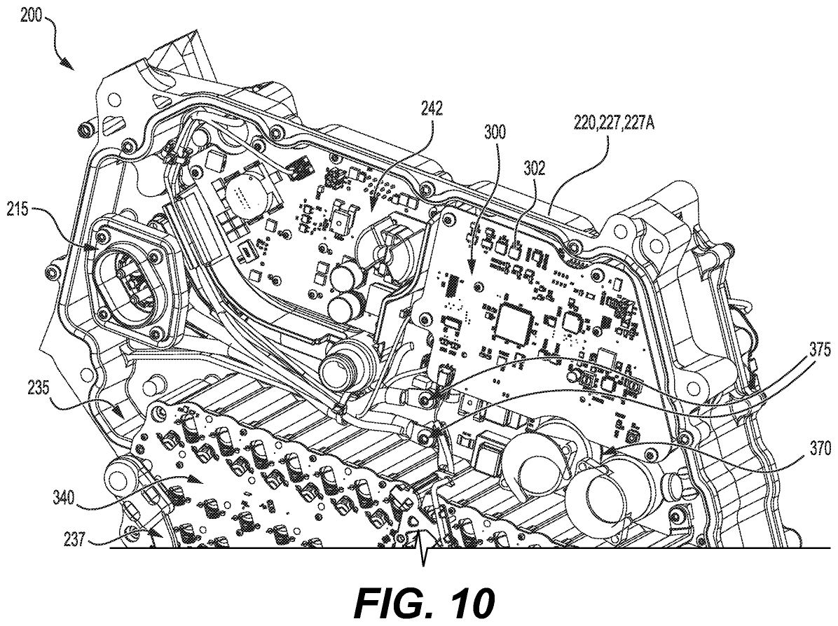

With reference to FIGS. 7 to 10, components of the battery pack 200 disposed inside the housing 220 are illustrated in more detail. As is mentioned briefly above, the battery pack 200 includes a plurality of battery cells 230 disposed in the housing 220. The battery pack 200 also includes a plurality of electronic components disposed in the battery housing 220. The electronic components include at least a DC-DC converter 242, a general battery management system (general BMS) 300, and a battery disconnect unit board (BDU board) 370. According to the present technology, the battery cells 230 and the DC-DC converter 242 is in direct thermal communication with the heat transfer channel 226. The heat transfer channel 226 is configured and arranged to provide heat transfer between the battery cells 230 and the DC-DC converter 242 and the heat transfer liquid flowing through the heat transfer channel 226 when the electric vehicle is in operation. The DC-DC converter 242, the general BMS 300, and the BDU board 370 will be described in more detail below.

The battery cells 230, in the illustrated embodiment, are arranged in a plurality of battery modules 235 disposed in the battery housing 220. In the present case, the battery pack 200 includes seven modules 235. It is contemplated that different embodiments of the battery pack 200 could include, and the battery cells 230 could be arranged in, more or fewer battery modules 235. In other non-limiting embodiments, it is contemplated that the battery cells 230 could be arranged differently than being grouped into modules.

In the illustrated embodiment, the battery modules 235 are separated into two banks of modules: a left bank 233 having three modules 235 disposed in the left chamber 225 of the housing 220, and a right bank 234 having four modules 235 disposed in the right chamber 229. As such, the left chamber 225, where the DC-DC converter 242, the general BMS 300, and the BDU board 370 are also disposed, has fewer battery cells 230 than the right chamber 229. Depending on the embodiment, the left and right banks 233, 234 of modules 235 could include more or fewer modules 235. It is also contemplated that the left and right banks 233, 234 could have equal numbers of modules 235. The left bank 233 has fewer modules 235 than the right bank 234 in the present embodiment, but it is contemplated that the right bank 234 could have fewer modules 235 than the left bank 233 (the DC-DC converter 242, the general BMS 300, and the BDU board 370 being disposed in the right chamber 229 for instance).

Each battery module 235 includes a portion of the battery cells 230. In the illustrated embodiment, each module 235 includes seventy battery cells 230. The battery pack 200 thus has a total of 490 (four hundred ninety) battery cells 230. It is contemplated that each battery module 235 could include more or fewer battery cells 230. Depending on the number of battery cells 230 in each module 235 and/or the total number of modules 235 in a given embodiment, it is also contemplated that the total number of battery cells 230 in the battery pack 200 could vary.

The battery cells 230 are cylindrical battery cells 230. In the present embodiment, the battery cells 230 are 3.5V cylindrical cells, such as LG™ M50L lithium ion cells in 21700 format, but it is contemplated that different versions of cells could be used in some embodiments. For example, battery cells could vary in nominal energy capacity, usable energy capacity, discharge rate, cell chemistry and cell type.

The battery modules 235 are arranged such that a long axis of each cylindrical battery cell 230 extends generally orthogonally to the center portion of the housing body 227 and the lateral outer surfaces of the left and right side covers 221, 223.

Each module 235 includes a module board 340 electrically connected to the battery cells 230 of the module 235. The module board 340 includes a module battery management system (module BMS) 350 for managing operation of the battery module 235. The module board 340 also includes an integrated current collector 345 disposed within the battery module 235. The integrated current collector 345 electrically couples the battery cells 230 together. In the present embodiment, the module board 340 thus serves to both collect current from the battery cells 230 and to monitor operating conditions of the battery cells 230 via the module BMS 350 in conjunction with the general BMS 300. Broadly, the general BMS 300 is communicatively connected to the module BMS 350 of each battery module 235.

As is noted above, the integrated current collector 345 of the module board 340 is electrically connected to the battery cells 230. Specifically, the integrated current collector 345 is configured to collect current from the battery cells 230 of the corresponding module 235 when the battery pack 200 is powering the vehicle and inversely for distributing electrical power to each battery cell 230 in the corresponding battery module 235 when the battery pack 200 is charging. In the current embodiment, the integrated current collector 345 is formed from a printed circuit board (PCB) 345 sized and arranged to cover an external side of the corresponding module 235.

Each bank 233, 234 of battery modules 235 is electrically connected together in series by a plurality of bus bars 237 to collect current from each module 235. The three PCBs 345 of the left bank 233 are electrically connected to one another in series via the bus bars 237 and the four PCBs 345 of the right bank 234 are electrically connected to one another in series via the bus bars 237. The two banks 233, 234 are connected together through a connecting bus bar 236 extending through the housing 220. The specific placement and forms of the bus bars 236, 237 could vary, depending on the particular embodiment.

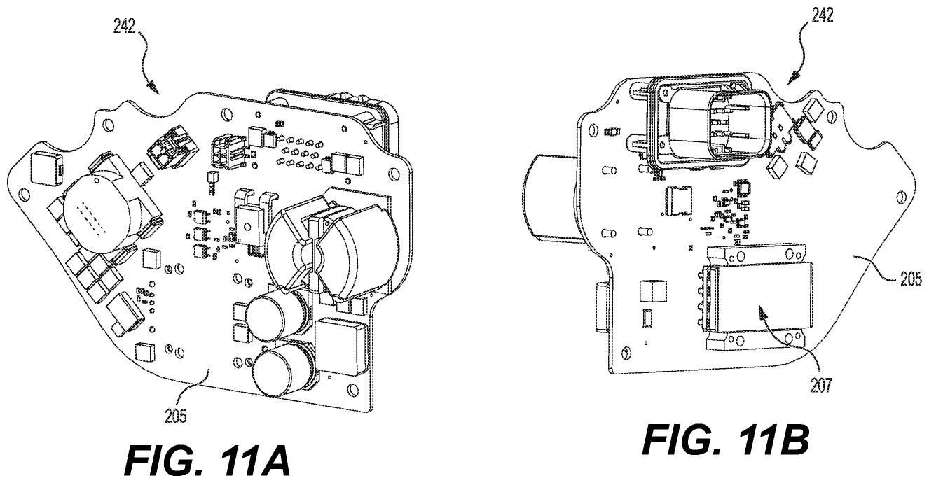

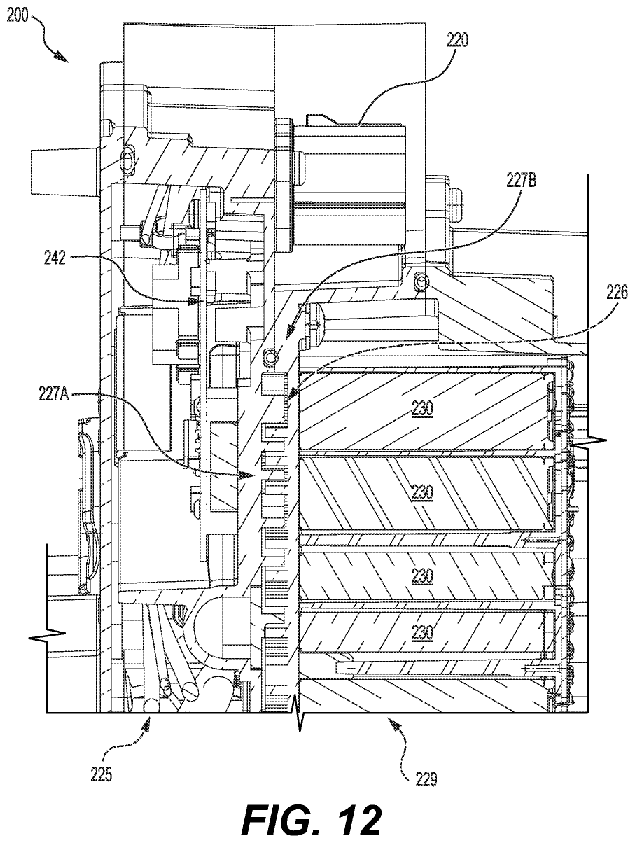

The heat transfer channel 226, disposed in the center portion 227 of the housing 220 as is described above, is in thermal communication with banks of battery cells 230 disposed on both a right side of the channel 226 and a left side of the channel 226. As can be further seen in FIGS. 11 and 12, inner ends of the battery cells 230 of each bank 233, 234 are in thermal communication with the heat transfer channel 226 through the housing body 227. When in operation, heat transfer liquid flowing through the battery heat transfer channel 226 generally absorbs heat from inner ends of the battery cells 230 on each lateral side of the battery heat transfer channel 226. When starting the electric vehicle in cold conditions, heat transfer liquid flowing through the battery heat transfer channel 226 may provide heat to the inner ends of the battery cells 230 on each lateral side of the battery heat transfer channel 226.

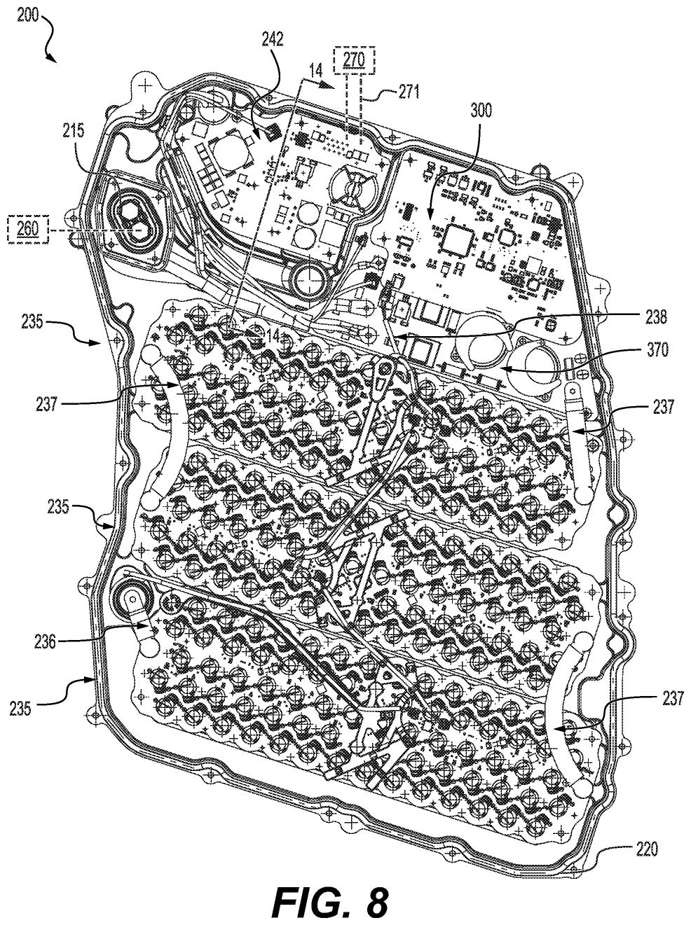

With reference to FIGS. 7, 8, and 10 to 14, the battery pack 200 includes a DC-DC converter 242 operatively connected to a twelve volt battery 270 (shown schematically in FIG. 8). As can be seen in FIGS. 11A and 11B, the DC-DC converter 242 is formed from a printed circuit board (PCB) 205 upon which the electric components are disposed. The DC-DC converter 242 includes a DC-DC switching element 207 connected to an interior side of the PCB 205 (i.e. on the side of the PCB 205 closer to the housing body 227. The electronic switching element 207 along with the other components on the DC-DC converter board perform the voltage conversion of the DC-DC converter 242 and the switching element 207 is often the most heat generating component of the DC-DC converter 242.

The DC-DC converter 242 is electrically connected to battery cells 230 in order to receive electricity therefrom. The DC-DC converter 242 is communicatively and operatively connected to the general BMS 350. The DC-DC converter 242 is arranged to provide power from the battery cells 230 to a low voltage circuit 271 (shown schematically in FIG. 8) in order to power different electrical components of the vehicle (other than the inverter 260) that operate at a lower voltage. In the present embodiments, the low voltage circuit 271 provides power to charge the twelve volt battery 270, the BDU board 370, and the general BMS 300. Additionally, the low voltage circuit 271 could further provide power to front and rear lights, navigation systems, on-board control units, dashboard displays, and sound systems.

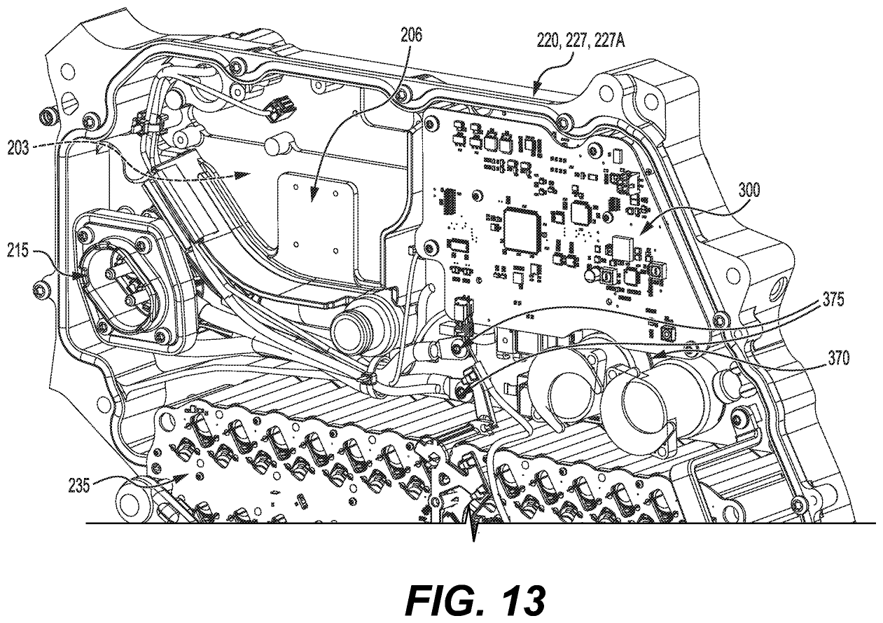

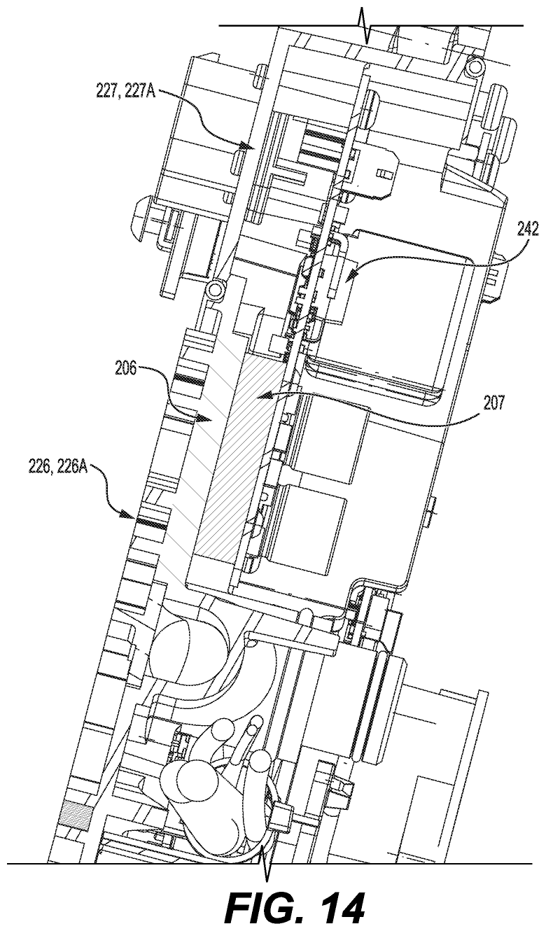

As is mentioned above, the DC-DC converter 242 is disposed in the left chamber 225 of the battery pack 200. The left lateral portion 227A specifically defines a space 203 for receiving the DC-DC converter 242 therein, as is illustrated in FIGS. 12 and 13. The housing body 227 includes a heat transfer pad 206 formed by the left lateral portion 227A and extending generally parallel to the heat transfer channel 226. The pad 206 is sized and arranged to contact the switching element 207 (more specifically the exterior housing thereof) to facilitate heat transfer between the housing of the switching element 207 and the housing body 227. As can be seen in FIG. 14, the DC-DC converter 242 is arranged such that the switching element 207 is in direct thermal communication with the heat transfer channel 226, with no air spaces therebetween.

As such, the DC-DC converter 242 is in direct thermal communication with the heat transfer channel 226. While other components disposed within the housing 220 may also benefit from heat transfer with the channel 226, the DC-DC converter 242 is arranged to thermally connect to the heat transfer channel 226 directly, with no air spaces therebetween to maximize the transfer of heat between the DC-DC converter 242 and heat transfer liquid in the channel 226. Heat from the DC-DC switching element 207 can transfer to the housing body 227 and into the heat transfer liquid in the channel 226 during operation via the pad 206. Portions of the DC-DC converter 242 thus directly contact the housing body 227, specifically the left lateral portion 227A partially defining the heat transfer channel 226. Depending on the embodiment, it is contemplated that additional or alternative electronic components could be arranged in the battery housing 220 and in direct contact with the housing body 227 in order to provide direct heat transfer between the component(s) and the heat transfer channel 226. These components could include, but are not limited to: the general BMS 300, the BDU board 370, the charger 250, the inverter 260, an electronic control unit (ECU, not shown), and a vehicle control unit (VCU, not shown).

Referring to FIGS. 7, 8, 10, and 15, the general battery management system (general BMS) 300 of the battery pack 200, and components thereof, will be described in more detail. As was mentioned briefly above, the general BMS 300 manages operation of the battery pack 200 and the battery modules 235 in conjunction with module BMS 350 of each battery module 235. The general BMS 300, also referred to as a global BMS 300, is configured for performing a variety of general management tasks for operating the battery pack 200.

The general BMS 300 is formed in part by a printed circuit board (PCB) 302, upon which electronic and electrical components of the general BMS 300 are disposed and connected. Depending on the embodiment, it is contemplated that components of the general BMS 300 could be secured to two or more PCBs 302.

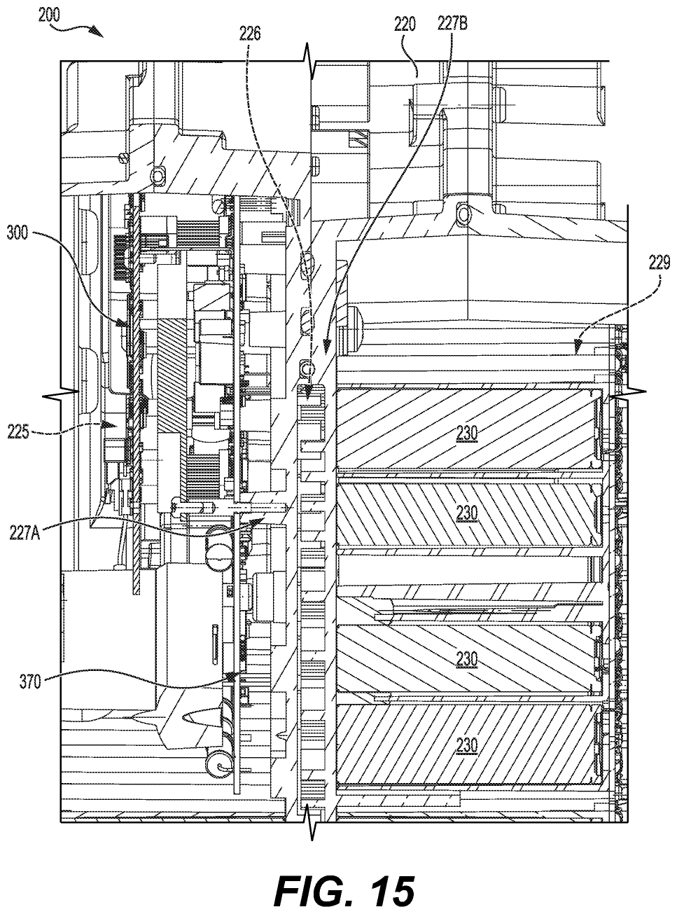

As is illustrated in FIG. 15, the general BMS 300 is also in thermal communication with the heat transfer channel 226. The arrangement of the general BMS 300 in relation to the heat transfer channel 226 is further described below.

With continued reference to FIGS. 7, 8, 10, and 15, the battery pack 200 further includes the battery disconnect unit board (BDU board) 370. In the present embodiment, portions of the BDU board 370 are disposed between the general BMS 300 and the center portions of the housing body 227. The BDU board 370 is generally arranged parallel to the general BMS 300. The BDU board 370 is operatively and communicatively connected to the general BMS 300. It is contemplated that all or some of the components of the BDU board 370 could be incorporated into the general BMS 300 and/or that the BDU board 370 and the general BMS 300 could be integrally connected. The general BMS 300 is configured to manage operation of various components of the BDU board 370.

In the illustrated embodiment, the BDU board 370 include two high voltage contactors 375. The high voltage contactors 375 are connected in series to the bus bars 237 and connected to the electric connector 215. Power drawn from the battery cells 230 is collected by the module PCBs 345, gathered by the bus bars 237, and then provided to the inverter 260 via the electric connector 215 via the BDU board 370. By passing the high voltage battery circuit through the BDU board 370, the BDU board 370 is arranged to interrupt the high voltage current flow when directed by the general BMS 300 or in response to signals from the BDU board controller 372.

As is also illustrated in FIG. 15, the BDU board 370 is in thermal communication with the heat transfer channel 226. Specifically, the BDU board 370 is mounted to the left lateral portion 227A of the housing body 227. As the left lateral portion 227A partially forms the heat transfer channel 226 and is formed from a heat conducting material, heat can transfer between the BDU board 370 and the left lateral portion 227A via heat transfer liquid flowing through the heat transfer channel 226 when the vehicle is in operation.

The general BMS 300 is also in thermal communication with the heat transfer channel 226, via the BDU board 370. Specifically, portions of the general BMS 300 are in direct contact with portions of the BDU board 370, which is in turn in direct contact with the left lateral portion 227A. While the electric components of the general BMS 300 and the BDU board 370 are not in direct contact with the housing body 227, some heat transfer between the general BMS 300 and the BDU board 370 and the heat transfer channel 226 during operation, due to the relative proximity of the general BMS 300 and the BDU board 370 to the housing body 227.

The heat transfer channel 226 is thus arranged to allow, when in operation, heat to be transferred to the heat transfer liquid flowing through the heat transfer channel 226 from the battery cells 230 and at least one of the electronic components 242, 300, 370 disposed therein and/or heat to be transferred from the heat transfer liquid flowing through the heat transfer channel 226 to the battery cells 230 and the electronic components 242, 300, 370 disposed therein. When the battery pack 200, or components therein, generate heat during operation of the electric vehicle, the heat transfer system is used to remove heat from the electronic components 242, 300, 370 and the battery cells 230 in order to maintain the components of the battery pack 200 within predetermined temperature limits. When operating the electric vehicle in cold conditions, the heat transfer system is used to provide heat to the electronic components 242, 300, 370 and the battery cells 230 in order to bring the components of the battery pack 200 up to a minimum operating temperature, including for example for vehicle start-up.

The battery park 200 implemented in accordance with some non-limiting implementations of the present technology can be represented as follows, presented in numbered clauses.

CLAUSE 1. A battery pack for an electric vehicle, the battery pack comprising: a battery housing including: a housing body, at least one heat transfer channel defined in the housing body, the at least one heat transfer channel extending generally through a center portion of the housing body, the at least one heat transfer channel being operative to convey a heat transfer fluid; a plurality of battery cells disposed in the housing body, the plurality of battery cells being disposed in direct thermal communication with the at least one heat transfer channel; and at least one electronic component disposed in the battery housing, the at least one electronic component being in direct thermal communication with the at least one heat transfer channel.

CLAUSE 2. The battery pack of clause 1, wherein the at least one electronic component includes a DC-DC converter; and the DC-DC converter is in direct thermal communication with the at least one heat transfer channel.

CLAUSE 3. The battery pack of clause 2, wherein at least a portion of the DC-DC converter directly contacts the housing body.

CLAUSE 4. The battery pack of any one of clauses 1 to 3, wherein the at least one heat transfer channel extends generally vertically through the center portion of the housing body.

CLAUSE 5. The battery pack of any one of clauses 1 to 4, further comprising a first cover selectively connected to the housing body, and a second cover selectively connected to the housing body; and wherein the plurality of battery cells includes: a first plurality of battery cells disposed in a first chamber defined by the housing laterally between the at least one heat transfer channel and the first cover, and a second plurality of battery cells disposed in a second chamber defined by the housing laterally between the at least one heat transfer channel and the second cover.

CLAUSE 6. The battery pack of clause 5, wherein each battery cell of the first plurality of battery cells extends generally orthogonally to the at least one heat transfer channel and the first cover; and each battery cell of the second plurality of battery cells extends generally orthogonally to the at least one heat transfer channel and the second cover.

CLAUSE 7. The battery pack of clauses 5 or 6, wherein the second plurality of battery cells has a greater number of battery cells than the first plurality of battery cells, the first chamber having less battery cells disposed therein than the second chamber.

CLAUSE 8. The battery pack of any one of clauses 5 to 7, wherein the first plurality of battery cells is a first plurality of cylindrical battery cells; and the second plurality of battery cells is a second plurality of cylindrical battery cells.

CLAUSE 9. The battery pack of clause 7 or 8, wherein the at least one electronic component is disposed in the first chamber.

CLAUSE 10. The battery pack of any one of clauses 5 to 9, wherein the housing body includes: a first lateral portion, and a second lateral portion connected to the first lateral portion; the first cover is selectively connected to the first lateral portion; the second cover is selectively connected to the second lateral portion; the at least one heat transfer channel is defined between the first lateral portion and the second lateral portion; and the center portion of the housing body is formed by an inner part of the first lateral portion and an inner part of the second lateral portion.

CLAUSE 11. The battery pack of clause 10, wherein an inner face of the first lateral portion includes a first channel form; an inner face of the second lateral portion includes a second channel form; and the at least one heat transfer channel is defined by a space created between the inner face of the first lateral portion and the inner face of the second lateral portion.

CLAUSE 12. The battery pack of any one of clauses 1 to 11, wherein the at least one heat transfer channel is arranged to allow, when in operation, at least one of heat to be transferred to the heat transfer fluid flowing through the at least one heat transfer channel from the plurality of battery cells and the at least one electronic component; and heat to be transferred from the heat transfer fluid flowing through the at least one heat transfer channel to the plurality of battery cells and the at least one electronic component.

CLAUSE 13. The battery pack of any one of clauses 1 to 12, wherein the at least one heat transfer channel is configured to convey a heat transfer liquid.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A battery pack for an electric vehicle, the battery pack comprising:
a battery housing including:
a housing body,
at least one heat transfer channel defined in the housing body, the at least one heat transfer channel extending generally through a center portion of the housing body, the at least one heat transfer channel being operative to convey a heat transfer fluid;
a plurality of battery cells disposed in the housing body, the plurality of battery cells being disposed in direct thermal communication with the at least one heat transfer channel; and
at least one electronic component disposed in the battery housing, the at least one electronic component being in direct thermal communication with the at least one heat transfer channel.

2. The battery pack of claim 1, wherein:
the at least one electronic component includes a DC-DC converter; and
the DC-DC converter is in direct thermal communication with the at least one heat transfer channel.

3. The battery pack of claim 2, wherein at least a portion of the DC-DC converter directly contacts the housing body.

4. The battery pack of claim 1, wherein the at least one heat transfer channel extends generally vertically through the center portion of the housing body.

5. The battery pack of claim 1, further comprising:
a first cover selectively connected to the housing body, and
a second cover selectively connected to the housing body; and
wherein:
the plurality of battery cells includes:
a first plurality of battery cells disposed in a first chamber defined by the housing laterally between the at least one heat transfer channel and the first cover, and
a second plurality of battery cells disposed in a second chamber defined by the housing laterally between the at least one heat transfer channel and the second cover.

6. The battery pack of claim 5, wherein:
each battery cell of the first plurality of battery cells extends generally orthogonally to the at least one heat transfer channel and the first cover; and
each battery cell of the second plurality of battery cells extends generally orthogonally to the at least one heat transfer channel and the second cover.

7. The battery pack of claim 5, wherein the second plurality of battery cells has a greater number of battery cells than the first plurality of battery cells, the first chamber having less battery cells disposed therein than the second chamber.

8. The battery pack of claim 5, wherein:
the first plurality of battery cells is a first plurality of cylindrical battery cells; and
the second plurality of battery cells is a second plurality of cylindrical battery cells.

9. The battery pack of claim 7, wherein the at least one electronic component is disposed in the first chamber.

10. The battery pack of claim 5, wherein:
the housing body includes:
a first lateral portion, and
a second lateral portion connected to the first lateral portion;
the first cover is selectively connected to the first lateral portion;
the second cover is selectively connected to the second lateral portion;
the at least one heat transfer channel is defined between the first lateral portion and the second lateral portion; and
the center portion of the housing body is formed by an inner part of the first lateral portion and an inner part of the second lateral portion.

11. The battery pack of claim 10, wherein:
an inner face of the first lateral portion includes a first channel form;
an inner face of the second lateral portion includes a second channel form; and
the at least one heat transfer channel is defined by a space created between the inner face of the first lateral portion and the inner face of the second lateral portion.

12. The battery pack of claim 1, wherein the at least one heat transfer channel is arranged to allow, when in operation, at least one of:
heat to be transferred to the heat transfer fluid flowing through the at least one heat transfer channel from the plurality of battery cells and the at least one electronic component; and
heat to be transferred from the heat transfer fluid flowing through the at least one heat transfer channel to the plurality of battery cells and the at least one electronic component.

13. The battery pack of claim 1, wherein the at least one heat transfer channel is configured to convey a heat transfer liquid.
